(19) United States
(12) Patent Application Publication
(10) Pub. No.: US 2011/0174248 A1
(43) Pub. Date: Jul. 21, 2011

(54) RESIDUAL BURNT GAS SCAVENGING METHOD IN A DIRECT-INJECTION SUPERCHARGED INTERNAL-COMBUSTION MULTI-CYLINDER ENGINE

(76) Inventor: Guillaume BRESSION, Vincennes (FR)

(21) Appl. No.: 13/006,447

(22) Filed: Jan. 14, 2011

(30) Foreign Application Priority Data
Jan. 19, 2010 (FR) 10/00.192

(51) Int. Cl. F02B 25/00

(52) U.S. Cl. 123/76

(57) ABSTRACT

The present invention relates to a method of scavenging the residual burnt gas of a direct-injection multi-cylinder internal-combustion engine (10), notably of diesel type, with a piston moving in a reciprocating motion between a top dead center (PMH) and a bottom dead center (PMB), wherein a burnt gas scavenging stage is carried out by means of a sequence of opening/closing at least one exhaust valve (18) during exhaust phase (E) of the engine and of at least one sequence of opening/closing at least one intake valve (28) during this exhaust valve opening/closing sequence.

According to the invention, the method consists in starting the sequence of opening/closing exhaust valve (18) at a crank angle (e1) located after the bottom dead center (PMBe) of the exhaust phase and in ending this sequence at most at the next top dead center (PMHa).

### FIELD OF THE INVENTION

The present invention relates to a method of scavenging the residual burnt gas of a direct-injection supercharged internal-combustion engine.

### BACKGROUND OF THE INVENTION

As it is widely known, the power delivered by an internal-combustion engine depends on the amount of air fed into the combustion chamber of this engine, this amount of air being itself proportional to the density of this air.

Thus, this amount of air is commonly increased by compression of the outside air before it is fed into this combustion chamber, when high power is required. This operation, referred to as supercharging, can be carried out using any means such as a turbocompressor or a driven compressor such as a screw compressor.

Furthermore, in order to increase even further this amount of air in the combustion chamber of the cylinder, the residual burnt gas initially contained in the dead volume of the combustion chamber is to be discharged at the top dead center of the piston and replaced by supercharged air. This stage is more commonly referred to as burnt gas scavenging and it is generally conducted before the end of the engine exhaust phase.

As it is known from document FR-2,886,342, this scavenging is carried out, at the end of the engine exhaust phase and at the start of the intake phase, by overlapping of the exhaust and intake valves of a cylinder. This overlap is obtained by opening simultaneously these exhaust and intake valves for some degrees to some ten degrees of crank rotation angle.

The intake air is thus fed into the combustion chamber before the end of the exhaust phase by expelling the exhaust gas contained therein. This gas is thus discharged through the exhaust valve and replaced by intake air.

Although this type of engine gives satisfactory results, it however involves drawbacks that are by no means insignificant.

In fact, such scavenging requires recesses of great depth in the piston, which consequently degrades the shape of the combustion chamber and the progress of the fuel mixture combustion. Furthermore, this type of engine requires concurrently modifying the opening angles of the exhaust valves and the closing angles of the intake valves.

Document FR-2,926,850 filed by the applicant describes another residual burnt gas scavenging method wherein an exhaust valve opening/closing sequence is carried out during the engine exhaust phase and, during this exhaust valve opening/closing sequence, an intake valve opening/closing sequence is carried out so as to achieve scavenging of the residual burnt gas.

Such a method involves the drawback according to which the exhaust pressure can be higher than the intake pressure well before the end of the scavenging phase.

This is generally due to the fact that the pressure wave of the exhaust gas coming from a neighbouring cylinder reaches the exhaust valve of the cylinder under scavenging, generally through the exhaust manifold, thus increasing the exhaust pressure of this cylinder.

This high exhaust pressure of this cylinder generates an obstacle to the discharge of the burnt gas to the exhaust, which prevents supercharged intake air from being fed into the combustion chamber. The amount of supercharged air contained in the combustion chamber is therefore not sufficient to obtain the desired engine power.

The present invention aims to overcome the aforementioned drawbacks by means of a scavenging method of simple design allowing to provide near-total discharge of the residual burnt gas while increasing filling of the combustion chamber with supercharged air without degrading the shape of this chamber.

### SUMMARY OF THE INVENTION

The present invention therefore relates to a method of scavenging the residual burnt gas of a direct-injection multi-cylinder internal-combustion engine, notably of diesel type, with a piston moving in a reciprocating motion between a top dead center and a bottom dead center, wherein a burnt gas scavenging stage is carried out by means of a sequence of opening/closing at least one exhaust valve during the exhaust phase of the engine and of at least one sequence of opening/closing at least one intake valve during this exhaust valve opening/closing sequence, characterized in that it consists in starting the sequence of opening/closing the exhaust valve at a crank angle located after the bottom dead center of the exhaust phase and in ending this sequence at most at the next top dead center.

The method can consist in starting the intake valve opening/closing sequence at the crank angle of the exhaust valve opening/closing sequence start.

The method can consist in starting the intake valve opening/closing sequence at a crank angle after the crank angle of the exhaust valve opening/closing sequence start.

The method can consist in performing closing of the intake valve at most at the end of the exhaust phase.

The method can consist in performing at least one intake valve opening/closing sequence in a zone of the exhaust phase where the pressure differential between the intake pressure and the exhaust pressure is the highest.

The method can consist in decreasing the height of the intake valve lift during the exhaust phase so that it is lower than the height of the exhaust valve lift.

### BRIEF DESCRIPTION OF THE FIGURES

Other features and advantages of the invention will be clear from reading the description hereafter, given by way of non limitative example, with reference to the accompanying figures wherein:

FIG. 1 shows an internal-combustion supercharged engine using the method according to the invention, p FIG. 2 shows curves illustrating the various lift laws (L) of the intake and exhaust valves of the cylinder during the scavenging stage, as a function of the crank rotation (in crank degrees °V) of the engine using the method according to the invention, and

FIG. 3 is a graph with curves illustrating the pressure (P in bar) at the intake (Pa) and at the exhaust (Pe) of a cylinder as a function of the crank rotation (in crank degrees °V).

### DETAILED DESCRIPTION

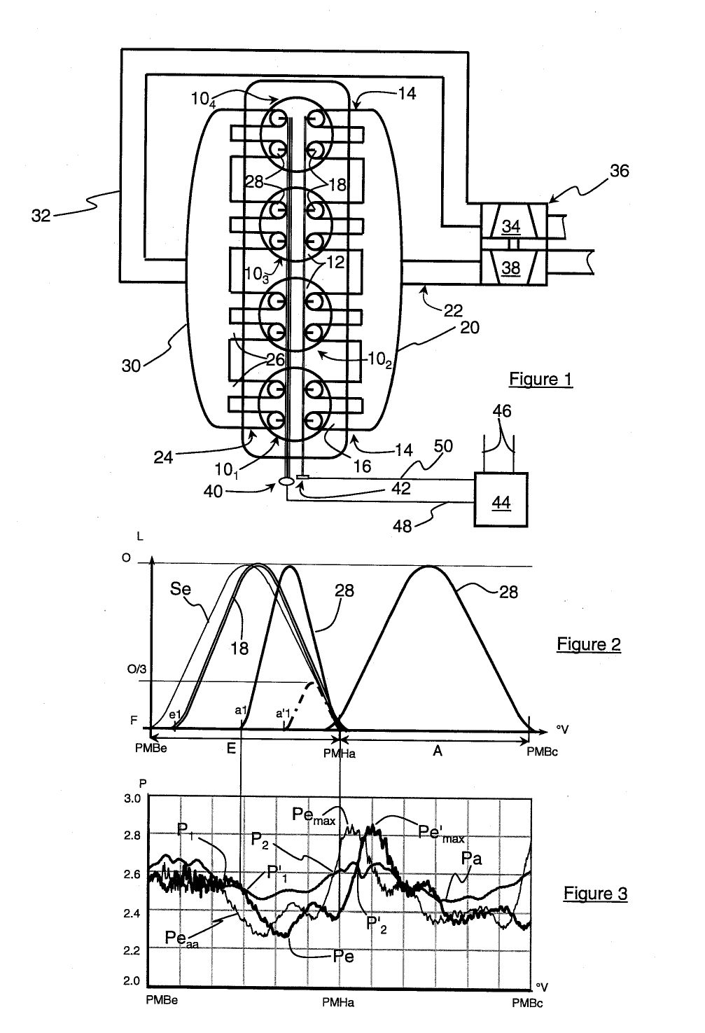

In FIG. 1, the internal-combustion engine illustrated is a supercharged internal-combustion engine of self-ignition type, notably a diesel engine, working in four-stroke mode with an intake phase A, a compression phase C, an expansion phase D and an exhaust phase E.

This engine comprises at least two cylinders 10, four cylinders 10₁ to 10₄ here, in which a piston (not shown) slides in a rectilinear reciprocating motion between a top dead center (PMH) and a bottom dead center (PMB) by delimiting a combustion chamber 12 in which combustion of a fuel mixture takes place.

As it is widely known, this fuel mixture can be either a mixture of supercharged air mixed with recirculated exhaust gas (or EGR) with a fuel, or a mixture of supercharged air with a fuel.

The cylinder comprises at least one burnt gas exhaust means 14, two here, including an exhaust pipe 16 associated with a shutoff means such as an exhaust valve 18.

Exhaust pipes 16 end in an exhaust manifold 20 allowing the burnt gas from the combustion chambers to be discharged, this manifold being connected to an exhaust line 22.

This cylinder also comprises at least one intake means 24, two here, including an intake pipe 26 controlled by a shutoff means such as an intake valve 28.

Usually, an intake manifold 30 is connected to intake pipes 26 and it allows fresh air (generally supercharged, mixed or not with recirculated exhaust gas) to be distributed in combustion chambers 12.

The intake manifold is connected by a line 32 to the outlet of compression section 34 of a turbocompressor 36, whereas exhaust manifold 20 is connected by line 22 to the inlet of turbine 38 of this turbocompressor.

Opening and closing of intake valves 28 is controlled by any known means allowing to vary the lift law of these valves. More particularly, these means allow to achieve a double lift of these valves during engine running conditions requiring high power, notably at low engine speeds, or a single lift under conventional running conditions at medium and high engine speeds.

Control means 40 of VVA (Variable Valve Actuation) camshaft type allowing the two lift laws of these valves to be achieved are therefore used. A first law allows to perform at least one sequence of opening/closing of intake valves 28 during exhaust phase E of the engine, followed by a conventional sequence of opening/closing of these valves during intake phase A. The other lift law allows to perform only a sequence of opening/closing of the intake valves during intake phase A of the engine.

By way of non limitative example, this camshaft comprises a cam associated with a second cam allowing to provide the double lift law for these intake valves during exhaust phase E and intake phase A of the engine, as well as a disengaging device making one of the cams, the second cam for example, inoperative, to achieve the single lift of the intake valves during the engine intake phase.

Opening and closing of exhaust valves 18 is controlled by control means 42 also allowing to vary the lift law of these valves. These means are also of VVA (Variable Valve Actuation) camshaft type allowing to achieve a variation of the crank angle at which opening of these exhaust valves starts, with or without modification of their crank angle at which closing during the exhaust phase takes place.

Of course, without departing from the scope of the invention, these control means 40 and 42 can be specific control means for each valve, such as an electromagnetic, electropneumatic actuator or other, directly acting on the valve rod.

It can be noted that the term “lift” corresponds to the graphical representation (along two axes) of the motion of a valve from the moment it starts opening the orifice of the pipe to the orifice full open position to the moment it ends closing this orifice.

This engine also comprises a processing unit 44 referred to as engine calculator that contains maps or data charts allowing, according to the values of the engine parameters transmitted by data lines 464, such as notably the intake pressure Pa in intake manifold 30 and the exhaust pressure Pe in exhaust manifold 20, the engine speed or the load thereof, to evaluate the power to be generated by this engine to meet the vehicle driver's request.

More precisely, this calculator allows, according to these values, to control the lift laws of intake valves 28 through a control line 48 acting upon means 40 so as to allow a single or a double lift of these valves. This calculator also allows to control the lift laws of exhaust valves 18 through a control line 50 acting upon means 42 so as to allow modification of their crank angle for opening and/or closing.

Thus, when the engine has to run under conditions corresponding to a high power requirement, the calculator controls this engine so that it works with scavenging of the residual burnt gas present in the combustion chamber when pressure Pa recorded in the intake manifold is higher than pressure Pe prevailing in the exhaust manifold.

In the example shown in this figure, the engine runs with a cycle 1, 3, 4, 2 wherein, during the combustion cycle and at a predetermined rotation angle of the crankshaft, cylinder 10₁ is at the end of the exhaust phase and at the beginning of the intake phase with a stage of scavenging the burnt gas present in the combustion chamber through simultaneous opening of the intake and exhaust valves, next cylinder 10₂ is in compression phase with the exhaust and intake valves in closed position, cylinder 10₃ in exhaust phase with opening of the exhaust valves and the last cylinder (cylinder 10₄) in expansion phase, the exhaust and intake valves being closed.

In order to prevent the pressure wave of the exhaust gas coming from the cylinder in exhaust phase and circulating in exhaust manifold 20 from disturbing the exhaust gas discharge during the stage of scavenging the burnt gas of the cylinder under scavenging, the crank angle is modified for the opening start of the exhaust valves of cylinder 10 under scavenging. It is therefore possible to position the peak of this pressure wave at the end of or after the stage of scavenging the cylinder concerned so that the pressure differential between the intake pressure and the exhaust pressure is favourable to the intake pressure, until closing of the exhaust valves.

FIG. 2 shows curves that illustrate the various lift laws of the intake 28 and exhaust 18 valves of cylinder 10 under scavenging between an open (O) and a closed (F) position as a function of the crank rotation angle (°V).

This figure is associated with FIG. 3 that illustrates the curves of the intake Pa and exhaust Pe pressures during these crank rotation angles.

For engines of the state of the art with burnt gas scavenging according to FR-2,926,850, exhaust valves Se follow (during exhaust phase E of the engine) a conventional opening/closing sequence between the exhaust bottom dead center (PMBe) and the intake top dead center (PMHa) of the piston, as illustrated by the curve in thin line, so as to discharge the exhaust gas contained in the combustion chamber towards exhaust manifold 20.

During this opening/closing sequence of exhaust valve Se, an opening/closing sequence of intake valve 28 is carried out so as to achieve scavenging of the residual burnt gas.

As can be seen in FIG. 3, the exhaust pressure curve Peₐₐ of this prior art comprises an intersection point P₁, located after exhaust bottom dead center PMBe, with intake pressure curve Pa beyond which the exhaust pressure is below the intake pressure. This curve Peₐₐ comprises another intersection point P₂, located before intake top dead center PMHa, with intake pressure curve Pa beyond which the exhaust pressure is above the intake pressure. Curve Peₐₐ continues until a pressure peak zone Peₘₐₓ resulting from the combination with the exhaust pressure wave coming from the neighbouring cylinder, then it decreases to around compression bottom dead center PMBc.

In this configuration, burnt gas scavenging is no longer performed from point P₂ considering the pressure differential in favour of the exhaust pressure while the exhaust and intake valves are still in open position. From this point and until closing of the exhaust valves at PMHa, an unwanted phase of burnt gas re-introduction into the combustion chamber takes place, accompanied by an expulsion through the intake valves of the supercharged air already present in the combustion chamber.

To prevent this, crank angle el for the start of the opening/closing sequence of exhaust valves 18 must not merge with PMBe but be located after this PMBe so as to obtain an exhaust pressure curve Pe shifted to the right, as illustrated in thick line in FIG. 3.

Advantageously, the value of this angle e1 ranges between 0° and 50° after the exhaust bottom dead center PMBe.

By shifting the start of the exhaust valves opening, point P′₁ with curve Pa is substantially shifted at a crank angle a1 and intersection point P′₂ with intake pressure curve Pa is located well after intake top dead center PMHa.

Exhaust pressure Pe therefore remains always below the intake pressure until closing of the exhaust valves by thus increasing the domain favouring burnt gas scavenging. Curve Pe continues until pressure peak zone point Pe′ₘₐₓ resulting from the combination with the exhaust pressure wave from the exhaust of the neighbouring cylinder.

This is due to the fact that the opening angle of the exhaust valve and therefore the pressure wave positioning determines the instantaneous exhaust pressure phasing, which is why Pe is shifted with respect to Peₐₐ by opening the exhaust valve later.

Thus, for engine running conditions that correspond to a high power requirement, exhaust valves 18 are controlled by control means 42 so as to follow, during exhaust phase E, an opening/closing sequence between point el after exhaust bottom dead center PMBe and intake top dead center PMHa.

Together with this exhaust valves opening/closing sequence, control means 40 are controlled by calculator 44 so as to achieve at least one sequence of opening/closing of intake valves 28 during this exhaust phase E and during the exhaust valves opening/closing sequence.

This sequence is more particularly carried out when the calculator receives information according to which the pressure Pa considered at the level of intake valves 28 is higher than the pressure Pe recorded at the level of exhaust valves 18.

More particularly, these intake valves open at angle a1 after angle e1 of the exhaust valves opening (or at this angle e1) and they close at intake top dead center PMHa by feeding supercharged air into the combustion chamber.

Considering the pressure differential between intake pressure Pa and exhaust pressure Pe favouring the intake pressure between angle a1 and PMHa, the exhaust gas contained in combustion chamber 12 is discharged through exhaust valves 18 towards exhaust manifold 20. This exhaust gas is thus replaced by supercharged air that allows to globally increase the amount of air present in the combustion chamber at the end of the engine intake phase A.

During this engine intake phase A that follows exhaust phase E, calculator 44 controls control means 40 of these intake valves 28 so that they open conventionally again in the vicinity of PMHa and close in the vicinity of compression bottom dead center PMBc.

The lift of the intake valves between angles a1 and PMHa corresponds to a zone of the exhaust phase wherein the pressure differential between intake pressure Pa and exhaust pressure Pe is globally the highest (see FIG. 3) for the exhaust phase considered while being positive for the intake pressure.

Advantageously, the lift height of the intake valves is substantially equal to the lift height of the exhaust valves, but the lift height of these intake valves may be varied, for example between a full open position O and a one-third open position O/3, so as to be able to control discharge of the residual burnt gas, as illustrated in mixed line in FIG. 2.

Similarly, the spread of the intake valves lift during the exhaust phase can be variable so as to start the opening/closing sequence at angle a1 and to end it at a crank angle located before PMHa.

Preferably, the maximum lift and the maximum spread of these intake valves during the exhaust phase are lower than those of the exhaust valves.

Thus, during the second lift of the intake valves, supercharged air adds further to the supercharged air already present in combustion chamber 12 after the scavenging operation so as to obtain a larger amount of air at the end of intake phase A.

Under conventional engine running conditions without burnt gas scavenging, calculator 44 controls control means 42 so as to achieve, during exhaust phase E, a conventional intake valves opening/closing sequence. This calculator also controls control means 40 so as not to achieve, during exhaust phase E, an opening/closing sequence of intake valves 18.

This exhaust phase is followed by an intake phase A during which the intake valves follow a conventional opening/closing sequence between PMHa and PMBc.

The invention thus readily allows to change from engine running conditions, with exhaust gas scavenging and possibility of adjusting the scavenging parameters (amount of burnt gas discharged, time of burnt gas discharge, etc.) by acting on the lift law of the intake valves during the exhaust phase, to conventional engine running conditions, and vice versa. Furthermore, the modularity of the intake law allows to manage scavenging of the residual burnt gas according to the pressure difference between the intake pressure and the exhaust pressure.

The present invention is not limited to the example described and it encompasses any variant or equivalent.

1) A method of scavenging the residual burnt gas of a direct-injection multi-cylinder internal-combustion engine, notably of diesel type, with a piston moving in a reciprocating motion between a top dead center and a bottom dead center, wherein a burnt gas scavenging stage is carried out by means of a sequence of opening/closing at least one exhaust valve during exhaust phase of the engine and of at least one sequence of opening/closing at least one intake valve during this exhaust valve opening/closing sequence, characterized in that it consists in starting the sequence of opening/closing the exhaust valve at a crank angle located after the bottom dead center of the exhaust phase and in ending this sequence at most at the next top dead center.

2) A method of scavenging the residual burnt gas of an engine as claimed in claim 1, characterized in that it consists in starting the opening/closing sequence of intake valve at crank angle of the opening/closing sequence start of exhaust valve.

3) A method of scavenging the residual burnt gas of an engine as claimed in claim 1, characterized in that it consists in starting the opening/closing sequence of intake valve at a crank angle after crank angle of the opening/closing sequence start of exhaust valve.

4) A method of scavenging the residual burnt gas of an engine as claimed in claim 1, characterized in that it consists in performing closing of intake valve at most at the end of exhaust phase.

5) A method of scavenging the residual burnt gas of an engine as claimed in claim 1, characterized in that it consists in performing at least one opening/closing sequence of intake valve in a zone (a1-PMHa) of the exhaust phase where the pressure differential between intake pressure and exhaust pressure is the highest.

6) A method of scavenging the residual burnt gas of an engine as claimed in claim 1, characterized in that it consists in decreasing the height of the lift of intake valve during the exhaust phase so that it is lower than the height of the exhaust valve lift.
